(19) United States
(12) Patent Application Publication
(10) Pub. No.: US 2026/0307721 A1
(43) Pub. Date: Oct. 8, 2026

(54) JOINT STRUCTURE OF VEHICLE BODY

(71) Applicants: HYUNDAI MOTOR COMPANY, SEOUL (KR); KIA CORPORATION, SEOUL (KR)

(72) Inventors: Hyuncheol Yun, Hwaseong-si (KR); Byeongkyu Kwon, Hwaseong-si (KR); Jongduk Yu, Hwaseong-si (KR); Hoyeon Kim, Hwaseong-si (KR)

(73) Assignees: HYUNDAI MOTOR COMPANY, SEOUL (KR); KIA CORPORATION, SEOUL (KR)

(21) Appl. No.: 19/567,866

(22) Filed: Mar. 16, 2026

(30) Foreign Application Priority Data
Apr. 2, 2025 (KR) 10-2025-0042539
Oct. 29, 2025 (KR) 10-2025-0158786

(51) Int. Cl. B62D 21/15; B62D 21/03; B62D 25/04; B62D 25/20; B62D 27/02

(52) U.S. Cl. CPC B62D 21/152; B62D 21/03; B62D 21/157; B62D 25/04; B62D 25/2036; B62D 27/02

(57) ABSTRACT

A joint structure of a vehicle body composed of a cutaway chassis cap forming a cabin section and a mounting section connected to the outside of the chassis cap is provided. The joint structure includes a partition panel forming the vertical cross-section of the cabin section and formed in a cutaway manner, an inner B pillar installed on the inner side of the cabin section and the partition panel, an upper cross member installed on the inner side of the cabin section to connect to the inner B pillar, a center side cross member installed on the inner side of the cabin section to connect to the inner B pillar, and a center lower cross member installed on the inner side of the cabin section to connect to the inner B pillar.

### CROSS-REFERENCE TO RELATED APPLICATION(S)

This application claims priority to and the benefit of Korean Patent Application No. 10-2025-0042539 filed with the Korean Intellectual Property Office on Apr. 2, 2025, and Korean Patent Application No. 10-2025-0158786 filed with the Korean Intellectual Property Office on Oct. 29, 2025, the entire contents of each are incorporated herein by reference.

### TECHNICAL FIELD

The present disclosure relates to a joining structure of a vehicle body of a vehicle, and relates to a joining structure of a vehicle body in which a plurality of reinforcements and cross members are provided on inner and outer sides of a cabin portion of a chassis cab body type vehicle, thereby improving a load path to distribute impact loads in an event of a side or rear collision of the vehicle.

### BACKGROUND

Recently, future mobility visions are being considered for a human-centered dynamic future city. One of these future mobility solutions is a PBV (purpose-built vehicle) for purpose-based mobility.

An example of a PBV vehicle is an eco-friendly vehicle based on an electric vehicle (EV). The body of the PBV vehicle may be composed of a cabin section that serves as a space for passengers and a mounting section where a cargo is placed, and the outer part of the cabin section may be manufactured as a cutaway chassis cap with a panel removed. Removing the panel may weaken the support structure of the chassis cap. Since the vehicle body of the mounting section supports the entire body structure of the vehicle body, the load resulting from the repeated loading of the heavy mounting section may weaken the durability of the entire body.

In this structure, the impact load caused by the rear or side collision of the vehicle may accelerate the bending phenomenon between the cabin and the mounting section, and is likely to cause the damage to the chassis cap.

Therefore, it would be useful to develop a vehicle body structure that may disperse the impact load due to the rear and side collisions at the connection part between the chassis cap and the cabin and mounting sections manufactured in the cutaway manner, and may respond to multi-specification PBVs.

### SUMMARY

Accordingly, the present disclosure is intended to solve the above-mentioned challenges, and to provide a joint structure of a vehicle body that maximizes rigidity and collision performance of the vehicle body by installing a reinforcement and a cross member on the inside of the cabin section in a chassis cap body type vehicle manufactured in the cutaway manner.

A joint structure of a vehicle body composed of a cutaway chassis cap forming a cabin section and a mounting section connected to the outside of the chassis cap according to an example embodiment of the present disclosure includes a partition panel forming the vertical cross-section of the cabin section and formed in a cutaway manner, an inner B-pillar (e.g., B pillar) installed on the inner side of the cabin section and installed to extend in the height direction of the vehicle body on the inner side of the partition panel, an upper cross member installed on the inner side of the cabin section and extending in a direction perpendicular to the height direction of the vehicle body to connect to the inner B pillar on the upper inner surface (or upper inner side) of the partition panel, a center side cross member installed on the inner side of the cabin section and extending in a direction perpendicular to the height direction of the vehicle body to connect to the inner B pillar on the inner side of the central portion of the partition panel, and a center lower cross member installed on the inner side of the cabin portion and extending in a direction perpendicular to the height direction of the body to connect to the inner B pillar on the lower inner side of the partition panel.

The joint structure of the vehicle body of an example embodiment of the present disclosure may further include a front outer upper reinforcement installed on the inner side of the cabin portion, connecting the inner B-pillar and the partition panel, and extending in the height direction of the body.

The joint structure of the vehicle body of an example embodiment of the present disclosure may further include an upper side gusset installed to connect the upper cross member and the inner B-pillar.

The joint structure of the vehicle body of an example embodiment of the present disclosure may further include a center side gusset installed to connect the center side cross member and the inner B-pillar.

The joint structure of the vehicle body of an example embodiment of the present disclosure may further include a lower side gusset installed to connect the center lower cross member and the inner B-pillar.

The joint structure of the vehicle body of an example embodiment of the present disclosure may further include a lower side vertical member installed on the inner surface of the lower center floor panel of the vehicle body and installed to connect the center lower cross member and the lower side gusset.

The joint structure of the vehicle body of an example embodiment of the present disclosure may further include a center side member bulkhead installed on the upper surface of the lower side vertical member and installed to connect the center lower cross member and the lower side gusset.

The joint structure of the vehicle body of an example embodiment of the present disclosure may further include a roof side center extension installed to connect the uppermost portion of the inner B pillar and the uppermost portion of the body.

The uppermost portion of the above partition panel and the above roof side center extension may be installed to connect to each other by an outer upper center pillar reinforcement.

The joint structure of the vehicle body of an example embodiment of the present disclosure may further include an upper side outer extension installed on the outer side of the cabin portion and extending in the height direction of the body on the outer surface of the partition panel.

The joint structure of the vehicle body of an example embodiment of the present disclosure may further include a lower side outer extension installed on the outside of the cabin portion and connected to the lower portion of the upper side outer extension.

The joint structure of the vehicle body of an example embodiment of the present disclosure may further include a side outer reinforcement installed on the outer side of the cabin portion and extending in the height direction of the body to the B pillar of the body.

The inner B-pillar and the side outer reinforcement may be combined to form a circular cross-section, and the side outer reinforcement combined with the front outer upper reinforcement may be combined with the upper side outer extension to form a circular cross-section.

The lower side vertical member combined with the center side member bulkhead may be combined with the lower center floor panel to form a circular cross-section.

The joint structure of the vehicle body of an example embodiment of the present disclosure may further include a side outer upper gusset installed on the upper side of the upper side outer extension to connect the side outer reinforcement and the upper side outer extension.

The joint structure of the vehicle body of an example embodiment of the present disclosure may further include a side outer center gusset installed on the central side of the upper side outer extension to connect the side outer reinforcement and the upper side outer extension.

The joint structure of the vehicle body of an example embodiment of the present disclosure may further include a side outer lower gusset installed on the lower side of the upper side outer extension to connect the side outer reinforcement and the upper side outer extension.

The impact transmitted from the central side of the above body to the above cabin may be (e.g., sequentially) transmitted through the side outer reinforcement, the side outer center gusset, and the center side gusset to the center side cross member.

The impact transmitted from the lower part of the above body to the (e.g., above) cabin part may be (e.g., sequentially) transmitted through the side outer reinforcement, side outer lower gusset, the lower side gusset, and the lower side vertical member to the center lower cross member.

The impact transmitted from the rear of the (e.g., above) body to the (e.g., above) cabin may be transmitted to the center side member bulkhead and branches into the center lower cross member, the lower side vertical member, and the lower side gusset. The impact branched from the lower side vertical member may be transmitted to the lower side bottom lane of the vehicle body, and the impact branched from the lower side gusset may be (e.g., sequentially) transmitted to the front outer upper reinforcement and the inner B-pillar.

According to an example embodiment of the present invention, by providing the plurality of reinforcements and cross members on the inner and outer sides of the cabin section in the chassis cap body type vehicle, the cabin section may be protected by distributing the impact load in the event of side or rear collisions of the vehicle.

In addition, a reduction in rigidity of the chassis cap due to the cutaway may be compensated for by applying the reinforcement structure of the annular cross-section.

Additionally, by improving and/or securing the rigidity of the vehicle body, damage to the battery installed in the vehicle may be prevented, and safety of passengers may be improved.

In addition, the joint structure of a vehicle body may be (e.g., easily and flexibly) adapted to various vehicle models by changing the location and number of the reinforcement and cross members according to the size and shape of the vehicle. Thus, investment and research and development costs may be reduced.

Additionally, when providing cutaway specifications, separate tuning work costs may be eliminated, and it is easy to implement the cutaway specifications when manufacturing inline bodies, making production easier.

### BRIEF DESCRIPTION OF THE DRAWINGS

FIG. 1 is a view showing a vehicle to which a body joint structure according to an example embodiment of the present disclosure is applied, as viewed from a side view.

FIG. 2 is a view showing a vehicle to which a body joint structure according to an example embodiment of the present disclosure is applied, as viewed from an inside of a cabin section.

FIG. 3 is a cross-sectional view taken along a line “A” of FIG. 2.

FIG. 4 is a cross-sectional view taken along a line “B” of FIG. 2.

FIG. 5 is a cross-sectional view taken along a line “C” of FIG. 2.

FIG. 6 is a cross-sectional view taken along a line “D” of FIG. 2.

FIG. 7 is a view showing a vehicle to which a joint structure of the vehicle body according to an example embodiment of the present disclosure is applied, as viewed from an outside of a cabin section.

FIG. 8 is a view showing a gusset and an extension coupled to a monocoque chassis cap of a body coupling structure according to an example embodiment of the present disclosure.

FIG. 9 is a view showing a vehicle having a body coupling structure according to an example embodiment of the present disclosure, as viewed from an inside of a cabin section.

FIG. 10 is a view showing a cutting path of a lateral impact in a cross-section taken along a line “E” of FIG. 9.

FIG. 11 is a view showing a cutting path of a lateral impact in a cross-section taken along a line “F” of FIG. 9.

FIG. 12 is a view showing a cutting path of a rear impact in a cross-section taken along a line “F” of FIG. 9.

### DETAILED DESCRIPTION

The present disclosure will be described more fully hereinafter with reference to the accompanying drawings, in which example embodiments of the disclosure are shown. The example embodiments may be modified in various different ways without departing from the present disclosure.

Further, in the example embodiments, like reference numerals designate like elements throughout the specification representatively in a first embodiment, and only elements of other embodiments other than those of the first embodiment may be described.

The drawings are schematic and not proportionally scaled down. Relative scales and ratios in the drawings are enlarged or reduced for the purpose of accuracy and convenience, and the scales are random and not limited thereto. In addition, like reference numerals designate like structures, elements, or parts throughout the specification. When an element such as a layer, film, region, or substrate is referred to as being “on” another element, it can be directly on the other element or intervening elements may also be present.

Embodiments of the disclosure are described through schematic illustrations of idealized embodiments of the disclosure. As such, variations from the shapes of the illustrations as a result are to be expected. Thus, example embodiments of the disclosure should not be construed to be limited to the particular shapes of regions illustrated herein but are to include deviations in shapes that result, for example, from manufacturing.

Hereinafter, with reference to the attached drawings, a joint structure of a vehicle body of a vehicle according to an example embodiment of the present disclosure will be described in detail.

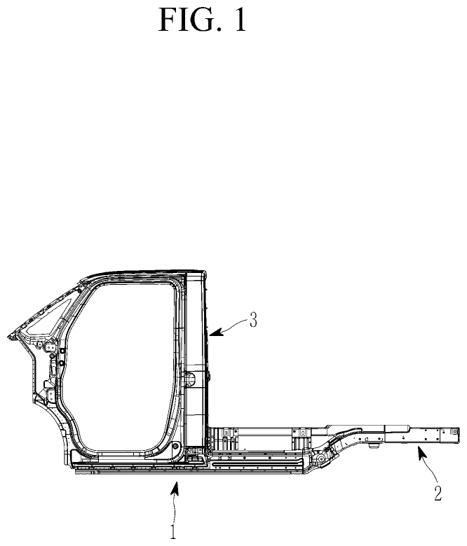

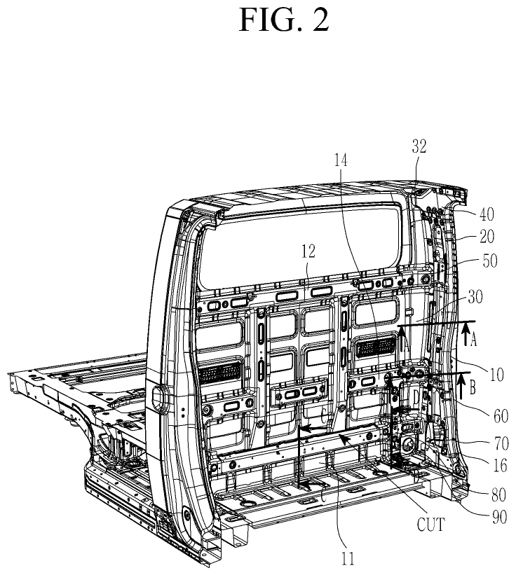

FIG. 1 is a view showing a side view of a vehicle to which a joint structure of a vehicle body according to an example embodiment of the present disclosure is applied, and FIG. 2 is a view showing a vehicle to which a joint structure of the vehicle body according to an example embodiment of the present disclosure is applied, as seen from an inside of a cabin section.

The joint structure of the vehicle body according to an example embodiment of the present disclosure may be applied to a purpose built vehicle (PBV) of a monocoque body type, and the vehicle body of the vehicle may be formed of a low-floor monocoque platform 1 and a coupled torsion beam axle (CTBA) mounting portion 2 formed to extend from the low-floor monocoque platform 1 and on which a CTBA is mounted.

A cabin section 3 that serves as a space for passengers may be formed in the front of the monocoque platform 1. The cabin section 3 may be formed of a cutaway chassis cap, and a CTBA mounting section 2 connected to the outside of the chassis cap may function as a (e.g., special) mounting section where cargo may be placed.

A plurality of flattening members and a plurality of ramps may be provided on the upper part of the monocoque platform 1, so that upper surfaces of the flattening members, upper surfaces of the ramps, and an upper surface of the body of the CTBA mounting portion 2 may be formed in a flat shape of (e.g., substantially) the same height. That is, by forming a flat surface between the monocoque platform 1 side and the CTBA mounting part 2 side, the (e.g., special) part may be flattened, and at (e.g., substantially) the same time, the load applied to the body in the event of a rear collision can be distributed.

As shown in FIG. 2, the cabin section 3 is provided with a partition panel 10 formed in a cutaway manner and forms a vertical cross-section of the cabin section 3. On the inner side of the cabin section 3 of the partition panel 10, an inner B-pillar 20, an upper cross member 12, a center side cross member 14, and a center lower cross member 16 are installed.

The inner B-pillar 20 is installed on the inner surface of the partition panel 10 to extend in the height direction of the vehicle body. The inner B-pillars 20 may be installed as a pair facing each other on both inner sides of the partition panel 10.

The upper cross member 12 may be installed on the upper inner surface (or upper inner side) of the partition panel 10 to extend in a direction perpendicular to the height direction of the vehicle body to be connected to the inner B-pillars 20 on both sides.

The center side cross member 14 may be installed on the inner surface of the central portion of the partition panel 10 to extend in a direction perpendicular to the height direction of the vehicle body to be connected to the inner B pillars 20 on both sides. The center side cross member 14 may extend in a direction parallel to the upper cross member 12. A plurality of center side cross members 14 may be provided. In an example embodiment, the center side cross members 14 may be provided in the center and on one or both sides of the partition panel 10.

The center lower cross member 16 may be installed to extend in a direction perpendicular to the height direction of the vehicle body to be connected to the inner B-pillars 20 on both sides on the lower inner surface of the partition panel 10.

In the inner B-pillar 20, a front outer upper reinforcement 30 may be installed to connect the inner B-pillar 20 and the partition panel 10. The front outer upper reinforcement 30 may be installed as a pair facing each other on the inner side of the inner B-pillar 20 and on the inner surfaces of both sides of the partition panel 10.

At the end of the upper cross member 12, an upper side gusset 50 may be installed to connect the upper cross member 12 and the inner B-pillar 20. The upper side gusset 50 may be provided as a pair on both ends of the upper cross member 12. Additionally, the upper side gusset 50 may connect the upper cross member 12 and the upper portion of the front outer upper reinforcement 30.

At the end of the center side cross member 14, a center side gusset 60 may be installed to connect the center side cross member 14 and the inner B-pillar 20. The center side gusset 60 may be provided as a pair on both ends of the center side cross member 14. Additionally, the center side gusset 60 may connect the center side cross member 14 and the center portion of the front outer upper reinforcement 30.

At the end of the center lower cross member 16, a lower side gusset 70 may be installed to connect the center lower cross member 16 and the inner B-pillar 20. The lower side gussets 70 may be provided as a pair on both ends of the center lower cross member 16. Additionally, the lower side gusset 70 may connect the center lower cross member 16 and the lower part of the front outer upper reinforcement 30.

The end of the center lower cross member 16 and the lower side gusset 70 may be connected by the lower side vertical member 90. The lower side vertical member 90 may be installed on the inner surface of the lower center floor panel 11 of the vehicle body and extend in the height direction of the vehicle body, and both sides of the lower center floor panel 11 may be connected to the center lower cross member 16 and the lower side gusset 70, respectively. The lower side vertical members 90 may be provided as a pair on each end of the center lower cross member 16.

On the upper surface of the lower side vertical member 90, a center side member bulkhead 80 may be installed to connect the center lower cross member 16 and the lower side gusset 70. The center side member bulkhead 80 may be provided as a pair, each installed on the upper surface of the lower side vertical member 90 on both sides.

At the top of the vehicle body, a roof side center extension 40 may be installed to connect the top of the inner B pillar 20 and the top of the vehicle body. The roof side center extension 40 may be provided as a pair, each installed at the top of the inner B pillar 20 on both sides.

The uppermost part of the partition panel 10 and the roof side center extension 40 may be installed to be connected to each other by an outer upper center pillar reinforcement 32. The outer upper center pillar reinforcement 32 can be provided as a pair, each installed on the roof side center extension 40 on both sides.

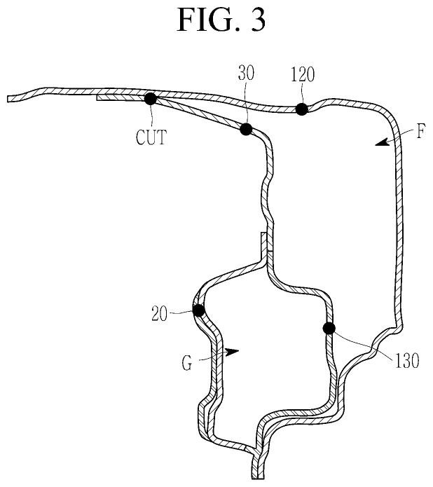

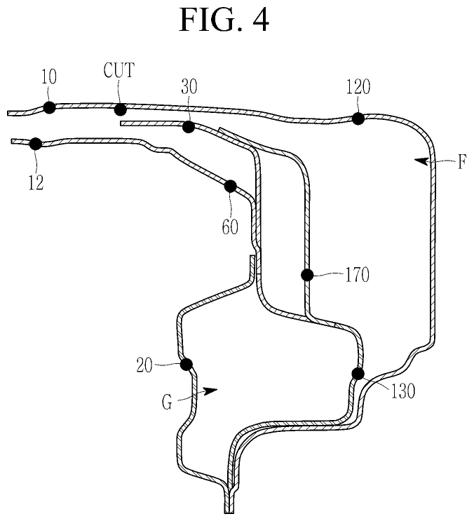

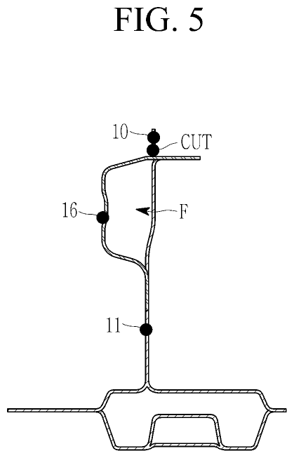

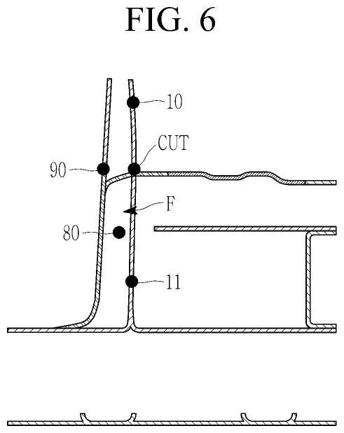

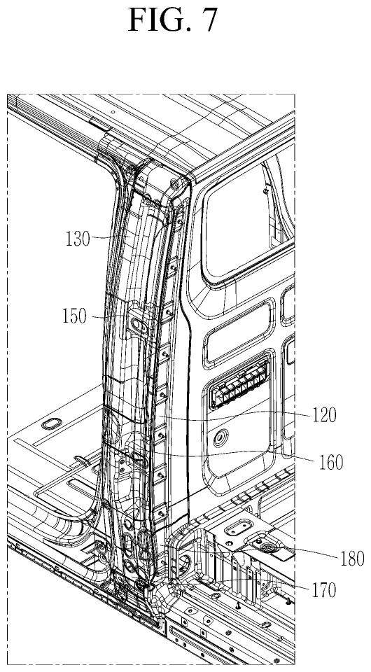

FIG. 3 is a cross-sectional view taken along a line “A” of FIG. 2, FIG. 4 is a cross-sectional view taken along a line “B” of FIG. 2, FIG. 5 is a cross-sectional view taken along a line “C” of FIG. 2, FIG. 6 is a cross-sectional view taken along a line “D” of FIG. 2, and FIG. 7 is a view of a vehicle having a joint structure of the vehicle body according to an example embodiment of the present disclosure as viewed from an outside of a cabin section.

First, referring to FIG. 7, on the outside of the cabin section 3, an upper side outer extension 120 may be installed on the outer surface of the partition panel 10 to extend in the height direction of the vehicle body.

Additionally, on the outside of the cabin section 3, a lower side outer extension 180 may be further installed to be connected to the lower portion of the upper side outer extension 120.

Additionally, a side outer reinforcement 130 may be further installed on the B pillar of the vehicle body on the outside of the cabin 3 to extend in the height direction of the vehicle body.

Additionally, a side outer upper gusset 150 may be further installed on the upper side of the upper side outer extension 120 to connect the side outer reinforcement 130 and the upper side outer extension 120.

Additionally, a side outer center gusset 160 may be further installed on the central side of the upper side outer extension 120 to connect the side outer reinforcement 130 and the upper side outer extension 120.

Additionally, a side outer lower gusset 170 may be further installed on the lower side of the upper side outer extension 120 to connect the side outer reinforcement 130 and the upper side outer extension 120.

Referring to FIG. 3, at the height between the upper cross member 12 and the center side cross member 14, the inner B pillar 20 and the side outer reinforcement 130 may be combined to form an annular cross section G, and the side outer reinforcement 130 combined with the front outer upper reinforcement 30 may be combined with the upper side outer extension 120 to form an annular cross section F.

Also, referring to FIG. 4, at the height where the center side cross member 14 is positioned, the inner B-pillar 20 and the side outer reinforcement 130 may be combined to form an annular cross-section G and the upper side outer extension 120 and the side outer lower gusset 170 may be combined to form an annular cross-section F.

In addition, as shown in FIG. 5, the center lower cross member 16 may be combined with the partition panel 10 to form an annular cross section F, and as shown in FIG. 6, the lower side vertical member 90 combined with the center side member bulkhead 80 may be combined with the lower center floor panel 11 to form an annular cross section F.

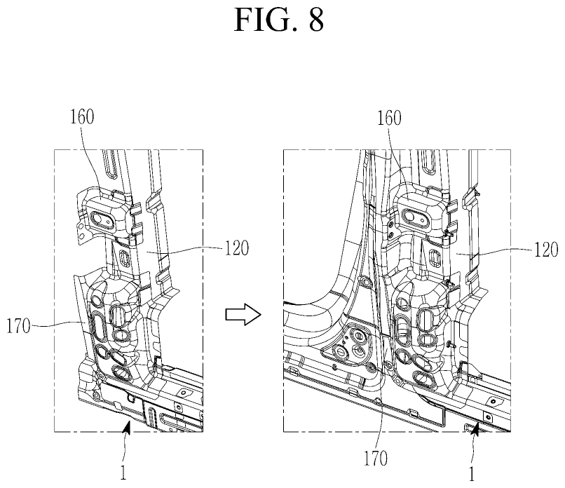

FIG. 8 is a view showing a state in which a gusset and an extension are coupled to a monocoque chassis cap of a body coupling structure according to an example embodiment of the present disclosure.

Referring to FIG. 8, an upper side outer extension 120 may be connected in the height direction of the vehicle to the lower part of a monocoque platform 1 extending in the longitudinal direction of the vehicle, and a side outer center gusset 160 may be installed in the central portion of the upper side outer extension 120. Additionally, a side outer lower gusset 170 may be installed on the lower portion of the upper side outer extension 120.

The assembled upper side outer extension 120, side outer center gusset 160, and side outer lower gusset 170 are attached to the partition panel 10 on the outside of the cabin section 3.

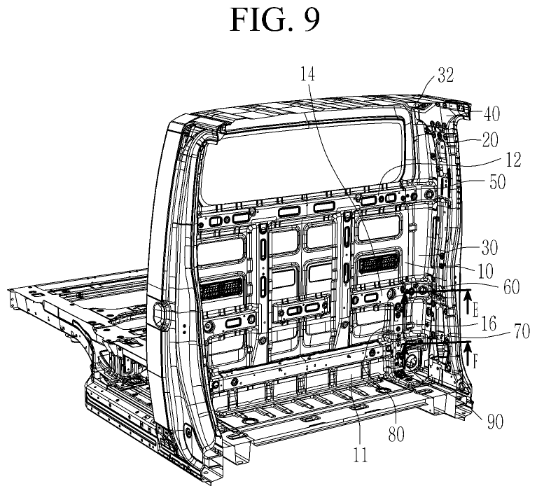

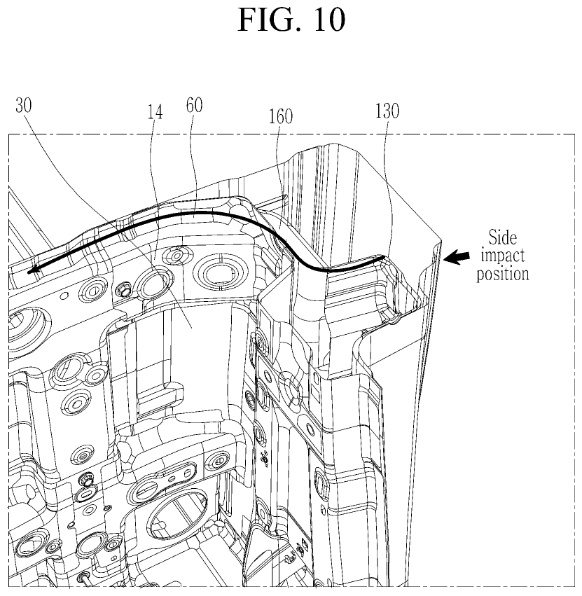

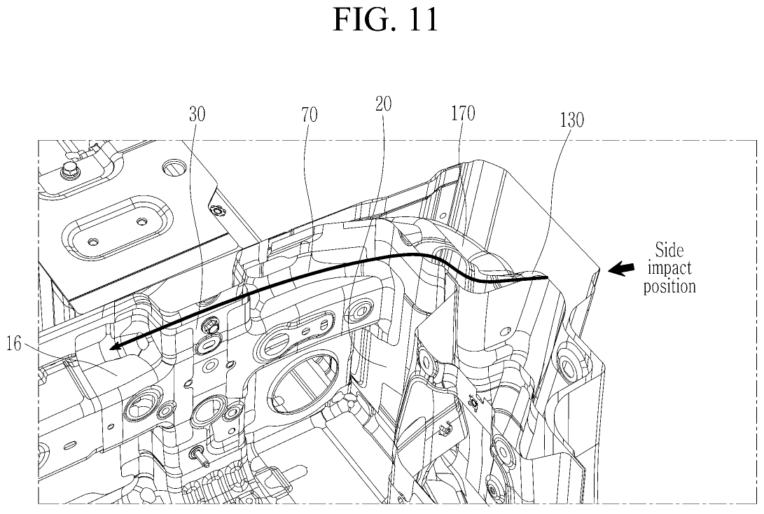

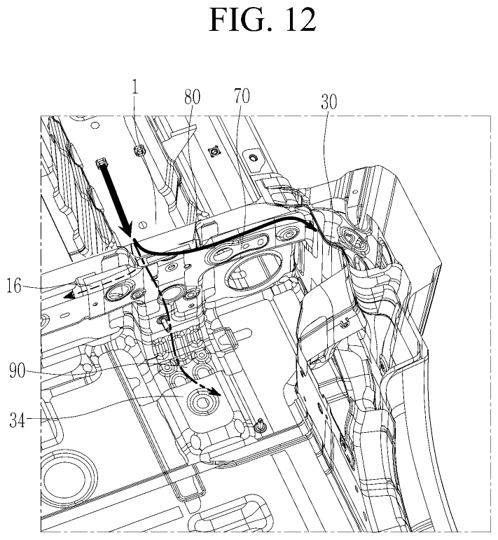

FIG. 9 is a view showing a vehicle having a body coupling structure according to an example embodiment of the present disclosure as viewed from an inside of a cabin section, FIG. 10 is a view showing a cutting path of a side impact in a cross-section taken along a line “E” of FIG. 9, FIG. 11 is a view showing a cutting path of a side impact in a cross-section taken along a line “F” of FIG. 9, and FIG. 12 is a view showing a cutting path of a rear impact in a cross-section taken along a line “F” of FIG. 9.

Referring to FIG. 9 and FIG. 10, an impact transmitted from the central side of the vehicle body to the cabin section 3 can be transmitted (e.g., sequentially) through the side outer reinforcement 130, the side outer center gusset 160, and the center side gusset 60, and then to the center side cross member 14.

Referring to FIGS. 9 and 11, the impact transmitted from the lower side of the vehicle body to the cabin section 3 may be transmitted (e.g., sequentially) through the side outer reinforcement 130, the side outer lower gusset 170, the lower side gusset 70, and the lower side vertical member 90 to the center lower cross member 16.

Referring to FIGS. 9 and 12, an impact transmitted from the rear of the vehicle body to the cabin section 3 may be transmitted to the center side member bulkhead 80 and branched to the center lower cross member 16, the lower side vertical member 90, and the lower side gusset 70.

The impact branched to the lower side vertical member 90 may be transmitted to the lower side bottom reinforcement 34 forming the bottom surface of the vehicle body, and the impact branched to the lower side gusset 70 may be (e.g., sequentially) transmitted to the front outer upper reinforcement 30 and the inner B-pillar 20.

According to an example embodiment of the present disclosure, by providing the plurality of reinforcements and cross members on the inner and outer sides of the cabin section in the chassis cap body type vehicle, the cabin section may be protected by distributing the impact load in the event of the side and/or rear collision(s) of the vehicle.

In addition, a reduction in the rigidity of the chassis cap due to the cutaway may be compensated for by applying the reinforcing structure of the annular cross-section.

Additionally, the damage to the battery installed in the vehicle may be prevented, and the safety of the passengers may be improved by securing the rigidity of the vehicle body.

In addition, it may be easily and flexibly adapted to various vehicle models by changing the location and number of the reinforcement and cross member(s) according to the size and shape of the vehicle, and investment, research, and development costs may be reduced.

Additionally, when providing cutaway specifications, separate tuning work costs may be eliminated, and when manufacturing an inline body, cutaway specifications may be easy to implement, making manufacturing easier in a production aspect.

Although the example embodiments of the present disclosure have been described above, the present disclosure is not limited to the above embodiments, and includes (e.g., all) changes that can be modified and deemed equivalent by a person having ordinary skill in the art to which the disclosure pertains from the embodiments of the present disclosure.

What is claimed is:

1. A joint structure of a vehicle body composed of a cutaway chassis cap forming a cabin section and a mounting section connected to an outside of the chassis cap, comprising:
a partition panel forming a vertical cross-section of the cabin section and formed in a cutaway manner;
an inner B pillar installed on an inner side of the cabin section and installed to extend in a height direction of the vehicle body on an inner side of the partition panel;
an upper cross member installed on the inner side of the cabin section and extending in a direction substantially perpendicular to the height direction of the vehicle body to connect to the inner B pillar on an upper inner side of the partition panel;
a center side cross member installed on the inner side of the cabin section and extending in a direction substantially perpendicular to the height direction of the vehicle body to connect to the inner B pillar on an inner side of a central portion of the partition panel; and
a center lower cross member installed on the inner side of the cabin section and extending in a direction substantially perpendicular to the height direction of the vehicle body to connect to the inner B pillar on a lower inner side of the partition panel.

2. The joint structure of the vehicle body of claim 1, further comprising:
a front outer upper reinforcement installed on the inner side of the cabin section, connecting the inner B pillar and the partition panel, and extending in the height direction of the vehicle body.

3. The joint structure of the vehicle body of claim 2, further comprising:
an upper side gusset installed to connect the upper cross member and the inner B pillar.

4. The joint structure of the vehicle body of claim 3, further comprising:
a center side gusset installed to connect the center side cross member and the inner B pillar.

5. The joint structure of the vehicle body of claim 4, further comprising:
a lower side gusset installed to connect the center lower cross member and the inner B pillar.

6. The joint structure of the vehicle body of claim 5, further comprising:
a lower side vertical member installed on an inner surface of a lower center floor panel of the vehicle body and installed to connect the center lower cross member and the lower side gusset.

7. The joint structure of the vehicle body of claim 6, further comprising:
a center side member bulkhead installed on an upper surface of the lower side vertical member and installed to connect the center lower cross member and the lower side gusset.

8. The joint structure of the vehicle body of claim 1, further comprising:
a roof side center extension installed to connect an uppermost portion of the inner B pillar and the uppermost portion of the vehicle body.

9. The joint structure of the vehicle body of claim 8, wherein:
the uppermost portion of the partition panel and the roof side center extension are installed to connect by an outer upper center pillar reinforcement.

10. The joint structure of the vehicle body of claim 7, further comprising:
an upper side outer extension installed on an outer side of the cabin section and extending in the height direction of the vehicle body on an outer surface of the partition panel.

11. The joint structure of the vehicle body of claim 10, further comprising:
a lower side outer extension installed on an outside of the cabin section and connected to a lower portion of the upper side outer extension.

12. The joint structure of the vehicle body of claim 10, further comprising:
a side outer reinforcement installed on the outer side of the cabin section and extending in the height direction of the vehicle body to the inner B pillar of the vehicle body.

13. The joint structure of the vehicle body of claim 12, wherein:
the inner B pillar and the side outer reinforcement form a circular cross-section, and
the side outer reinforcement with the front outer upper reinforcement and the upper side outer extension form a circular cross-section.

14. The joint structure of the vehicle body of claim 13, wherein:
a lower side vertical member with the center side member bulkhead and the lower center floor panel form a circular cross-section.

15. The joint structure of the vehicle body of claim 12, further comprising:
a side outer upper gusset installed on an upper side of the upper side outer extension to connect the side outer reinforcement and the upper side outer extension.

16. The joint structure of the vehicle body of claim 15, further comprising:
a side outer center gusset installed on a central side of the upper side outer extension to connect the side outer reinforcement and the upper side outer extension.

17. The joint structure of the vehicle body of claim 16, further comprising:
a side outer lower gusset installed on a lower side of the upper side outer extension to connect the side outer reinforcement and the upper side outer extension.

18. The joint structure of the vehicle body of claim 17, wherein:
impact transmitted from a central side of the vehicle body to the cabin section is transmitted through the side outer reinforcement, the side outer center gusset, and the center side gusset to the center side cross member.

19. The joint structure of the vehicle body of claim 17, wherein:
impact transmitted from a lower part of the vehicle body to the cabin section is transmitted through the side outer reinforcement, side outer lower gusset, the lower side gusset, and the lower side vertical member to the center lower cross member.

20. The joint structure of the vehicle body of claim 17, wherein:
impact transmitted from a rear of the vehicle body to the cabin section is transmitted to the center side member bulkhead and branches into the center lower cross member, the lower side vertical member, and the lower side gusset,
impact branched from the lower side vertical member is transmitted to a lower side bottom lane of the vehicle body, and
impact branched from the lower side gusset is transmitted to the front outer upper reinforcement and the inner B pillar.
